(19) United States
(12) Patent Application Publication
(10) Pub. No.: US 2026/0048357 A1
(43) Pub. Date: Feb. 19, 2026

(54) GAS DECOMPOSITION DEVICE AND GAS DECOMPOSITION METHOD

(71) Applicant: Ushio Denki Kabushiki Kaisha, Tokyo (JP)

(72) Inventors: Yuichi OTSUKA, Tokyo (JP); Takanori SAMEJIMA, Tokyo (JP)

(73) Assignee: Ushio Denki Kabushiki Kaisha, Tokyo (JP)

(21) Appl. No.: 19/099,623

(22) PCT Filed: Jun. 21, 2023
(86) PCT No.: PCT/JP2023/022862

§ 371 Date: Jan. 29, 2025

(30) Foreign Application Priority Data
Aug. 3, 2022 (JP) 2022-123735

(51) Int. Cl. B01D 53/00

(52) U.S. Cl. CPC B01D 53/007; B01D 2257/402; B01D 2259/804

(57) ABSTRACT

The gas decomposition device includes: a pipe through which a gas to be treated containing oxygen and dinitrogen monoxide flows; a first light source that irradiates an inside of the pipe with first light having a main emission wavelength of 160 nm or more and less than 200 nm; and a second light source that irradiates the inside of the pipe with second light having a main emission wavelength of 200 nm or more and less than 411 nm, in which the first light source and the second light source are disposed such that at least a part of the second light overlaps with at least a part of the first light, and decompose the dinitrogen monoxide.

### TECHNICAL FIELD

The present invention relates to a gas decomposition device and a gas decomposition method.

### BACKGROUND ART

Since the industrial revolution, due to the increasing global average temperature, global warming countermeasures have become an urgent issue. As a greenhouse gas that causes global warming, carbon dioxide, methane, dinitrogen monoxide, chlorofluorocarbon gas, and the like are known. Among these gases, carbon dioxide emissions are the largest, followed by methane emissions, followed by dinitrogen monoxide emissions. However, it is reported that the global warming potential of methane is 25 times the global warming potential of carbon dioxide, and the global warming potential of dinitrogen monoxide is 298 times the global warming potential of carbon dioxide. In particular, the effect of global warming due to the emission of dinitrogen monoxide is not negligible.

A large amount of dinitrogen monoxide is discharged not only from industrial activities such as production of chemical products and combustion of waste, but also from human and livestock animal excreta treatment processes and agriculture. In recent years, because the concentration of dinitrogen monoxide shows an upward tendency, it is expected as a global warming countermeasure to suppress an increase in the concentration of dinitrogen monoxide or to reduce the concentration thereof.

Conventionally, a high temperature combustion method and a catalyst method have been used as methods for decomposing dinitrogen monoxide. However, in the high temperature combustion method, a large amount of energy is required to burn the gas. When fossil fuels are used to secure a large amount of energy, carbon dioxide emissions increase, and therefore it cannot be said that the use of fossil fuels is efficient as a global warming countermeasure. Also in the catalyst method, the gas needs to be heated up to a high temperature. Furthermore, ammonia used for a catalyst and a reducing agent needs to be procured, and there is also a problem of wastewater treatment after treatment. Therefore, it cannot also be said that the catalyst system is efficient.

As a method for chemically changing dinitrogen monoxide, a method of oxidizing dinitrogen monoxide by irradiation with ultraviolet light is known. For example, Patent Document 1 describes a sterilization device that oxidizes dinitrogen monoxide to generate a sterilizing gas containing NO or NO₂.

### PRIOR ART DOCUMENT

### Patent Document

Patent Document 1: JP-A-2016-083193

### SUMMARY OF THE INVENTION

### Problems to be Solved by the Invention

The present invention provides a gas decomposition device and a gas decomposition method that can efficiently decompose a greenhouse gas with a simpler structure or method.

### Means for Solving the Problems

A gas decomposition device according to the present invention includes: a pipe through which a gas to be treated containing oxygen and dinitrogen monoxide flows;
a first light source that irradiates an inside of the pipe with first light having a main emission wavelength in a range of 160 nm or more and less than 200 nm; and
a second light source that irradiates the inside of the pipe with second light having a main emission wavelength in a range of 200 nm or more and less than 411 nm, in which
the first light source and the second light source are disposed such that at least a part of the second light overlaps with at least a part of the first light, and decompose the dinitrogen monoxide.

In the present description, “oxygen” in a case of being simply referred to as “oxygen” means “oxygen molecules” (hereinafter, sometimes referred to as “O₂”). Although details will be described later, the first light directly decomposes dinitrogen monoxide (hereinafter, sometimes referred to as “N₂O”), and meanwhile, an excited atom generated by irradiation with the first light (the excited atom being referred to as “singlet oxygen” or “O (¹D)”, and hereinafter, sometimes referred to as “O(¹D)”) decomposes N₂O. Further, by the irradiation with the second light having a longer wavelength than the first light, O(¹D) is generated from ozone (hereinafter, sometimes referred to as “O₃”) secondarily generated by irradiation with the first light. The generated O(¹D) is utilized for decomposition of N₂O. That is, by the irradiation with the second light in addition to the irradiation with the first light, decomposition of N₂O can be promoted. Therefore, the greenhouse gas can be efficiently reduced. The gas decomposition device used as a global warming countermeasure has a technical idea fundamentally different from the technique described in Patent Document 1 in which N₂O is oxidized to generate NO or NO₂ gas having a sterilization effect.

The first light source may be disposed in the inside of the pipe, and the second light source is disposed on an outside of the pipe, and
the pipe may include a transmission region through which the second light passes. By disposing the first light source in the inside of the pipe, the first light emitted from the first light source does not need to pass through the pipe, and therefore, the choices of materials that can be used for the pipe can be expanded.

The gas to be treated may form a laminar flow in a space to be irradiated with the first light and a space to be irradiated with the second light. In order to form the laminar flow, obstacles with which the gas to be treated flowing between the surface of the light source and the inner wall of the pipe collides are preferably made as small as possible or as few as possible. By suppressing the collision of the gas to be treated with any obstacle, decomposition of generated ozone is prevented.

The first light source may be an excimer lamp. The main wavelength of the excimer light may be 172 nm or near 172 nm. Such excimer light is obtained by turning on a xenon excimer lamp in which xenon gas is sealed in a light emitting tube. The excimer lamp is a light source that can be stably mass-produced, and has a high cost reduction effect. The power supplied to the excimer lamp is controlled by a controller. The controller controls turning on and off of the excimer lamp.

In the present description, “near 172 nm” refers to a region within a range of 172 nm±5 nm. In this description, the “main wavelength” indicates, in a case where a wavelength range Z (A) of #10 nm with respect to a certain wavelength λ is defined on an emission spectrum, a wavelength λi in a wavelength range Z(λi) showing integrated intensity of 40% or more with respect to the total integrated intensity in the emission spectrum. In a light source such as a xenon excimer lamp in which a light source that emits light of the “main wavelength” has an extremely narrow half-value width and exhibits high light intensity only at a specific wavelength, usually, the wavelength (peak wavelength) at which the light intensity is relatively the highest may be regarded as the main wavelength.

A gas decomposition method includes: while a gas to be treated containing oxygen and dinitrogen monoxide is made to flow in to a chamber,
irradiating the chamber with first light having a main emission wavelength in a range of 160 nm or more and less than 200 nm from a first light source; and
irradiating the chamber with second light having a main emission wavelength in a range of 200 nm or more and less than 411 nm from a second light source, the second light being overlapping in at least a part of the second light with at least a part of the first light, and decomposing the dinitrogen monoxide.

The pipe or the chamber may have a connection port connected to a space in which a gas containing 5 vol % or less of the dinitrogen monoxide is present. The “space in which 5 vol % or less of the gas containing dinitrogen monoxide is present” is, for example, a sewer or a septic tank, or a drainage pipe, a drainage tank, an exhaust pipe, and an exhaust tank of a biomass plant, a waste treatment plant, or a chemical factory. Even in a case where dinitrogen monoxide has a low concentration of 5 vol % or less, decomposition is possible. Note that, even in a case where the concentration of dinitrogen monoxide exceeds 5 vol %, decomposition is possible.

### Effect of the Invention

With the above configuration, a gas decomposition device and a gas decomposition method that can efficiently decompose a greenhouse gas with a simpler structure or method can be provided. The provision of such a gas decomposition method and gas decomposition device greatly contributes to Goal 13 “Take urgent action to combat climate change and its impacts” of the Sustainable Development Target (SDGs) led by the United Nations.

### BRIEF DESCRIPTION OF THE DRAWINGS

FIG. 1A is a view illustrating an embodiment of a gas decomposition device.

FIG. 1B is a cross-sectional view taken along a line S1-S1 in FIG. 1A.

FIG. 2 illustrates an absorption cross section of a molecule with respect to an ultraviolet light irradiation wavelength.

FIG. 3A shows a gas decomposition device of a first modification.

FIG. 3B is a cross-sectional view taken along a line S2-S2 in FIG. 3A.

FIG. 4A shows a gas decomposition device of a second modification.

FIG. 4B is a cross-sectional view taken along a line S3-S3 in FIG. 3A.

### MODE FOR CARRYING OUT THE INVENTION

An embodiment of the present invention will be described with reference to the drawings as appropriate. Note that the drawings excluding the graph are all schematically illustrated, and the dimensional ratios in the drawings do not necessarily coincide with the actual dimensional ratios, and the dimensional ratios do not necessarily coincide between the drawings.

### [Outline of Gas Decomposition Device]

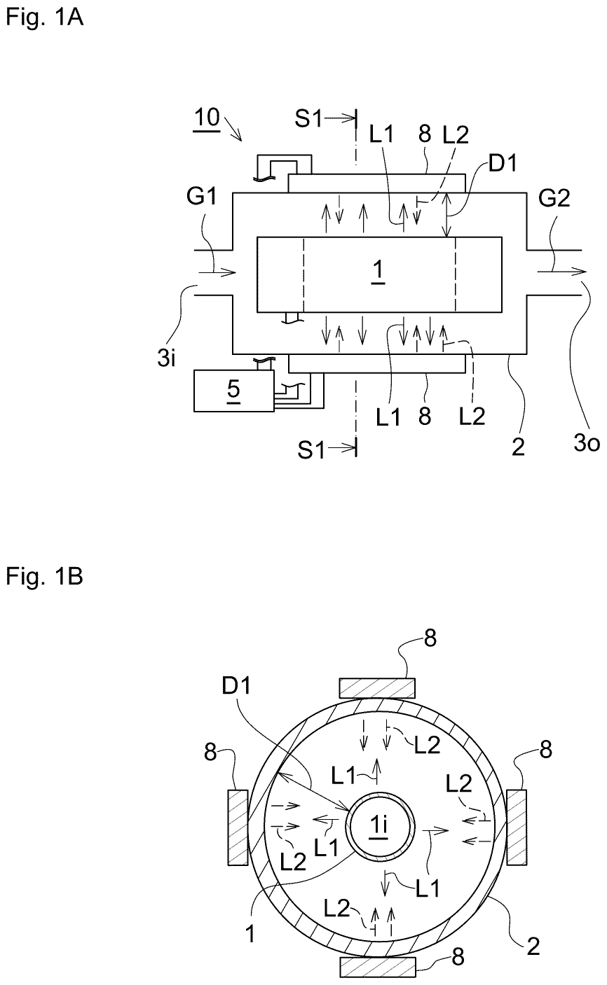

FIG. 1A is a view illustrating an embodiment of a gas decomposition device. FIG. 1B is a cross-sectional view taken along a line S1-S1 in FIG. 1A. The gas decomposition device 10 includes a chamber 2, a first light source 1 that emits first light L1 having a main emission wavelength in a range of 160 nm or more and less than 200 nm, and a second light source 8 that emits second light L2 having a main emission wavelength in a range of 200 nm or more and less than 411 nm. In the present description, the first light L1 emitted from the first light source 1 is exemplified by a solid arrow directed outward from the first light source 1. Further, the second light L2 emitted from the second light source 8 is exemplified by a broken arrow directed outward from the second light source 8.

The first light source 1 and the second light source 8 are disposed such that at least a part of the second light L2 overlaps with at least a part of the first light L1. This indicates that the photochemical reaction by the first light L1 and the photochemical reaction by the second light L2 can occur at the same place.

In the present embodiment, the first light source 1 is disposed in the inside of the chamber 2, and the second light source 8 is disposed on the outside of the chamber 2. In the present embodiment, a plurality of the second light sources 8 is disposed so as to surround the chamber 2, and emits the second light L2 toward the first light source 1. The chamber 2 includes a transmission region through which the second light L2 from the second light source 8 is transmitted.

In the present embodiment, the chamber 2 is a pipe including a gas supply port 3i and a gas discharge port 3o. The gas supply port 3i and the gas discharge port 3o are disposed to face each other with the first light source 1 interposed therebetween. Gas G1 is supplied from the gas supply port 3i to the chamber 2, the gas G1 flowing through the pipe and being the gas to be treated is irradiated with the first light L1 and the second light L2, and gas G2 obtained after the light irradiation is discharged from the gas discharge port 3o. The above processing can be performed continuously. In performing the irradiation with the first light L1 and the second light L2, the gas preferably maintains a laminar flow without colliding with an obstacle to form a turbulent flow. This prevents ozone generated by the irradiation with the first light L1 from being decomposed by the collision with obstacles.

Each of the first light source 1 and the second light source 8 is electrically connected to a controller 5. By the power being supplied from the controller 5 to the first light source 1 and the second light source 8, the first light source 1 and the second light source 8 are turned on.

In the present embodiment, the first light source 1 is a xenon excimer lamp that emits excimer light having a peak wavelength of 172 nm. In the xenon excimer lamp of the present embodiment, xenon gas is sealed in an interior 1i (see FIG. 1B) of the light emitting tube. The light emitting tube of the present embodiment has a cylindrical shape. However, the shape of the light emitting tube is not limited to a cylindrical shape. In addition, the first light source 1 is not limited to a xenon excimer lamp, and may be, for example, a low-pressure mercury lamp. The first light source 1 may be an excimer lamp in which gas other than xenon is sealed. The first light source 1 may be a solid light source such as a light-emitting diode (LED) or a laser diode (LD).

The first light L1 is easily absorbed by the gas G1, and the first light L1 does not reach far. Therefore, an interval D1 (see FIG. 1A or 1B) between the surface of the light emitting tube of the first light source 1 and the inner wall of the chamber 2 is relatively narrow. The interval D1 is preferably, for example, 50 mm or less, and preferably 30 mm or less. By setting the interval D1 to an appropriate distance at which the light is not excessively attenuated, the gas G1 passing through the chamber 2 without being irradiated with the first light L1 can be reduced. In the present embodiment, the chamber 2 has a pipe shape, but the chamber 2 may not have a pipe shape.

In the present embodiment, the second light source 8 uses a low-pressure mercury lamp that emits ultraviolet light having a peak wavelength of 254 nm. However, the second light source 8 may be a solid light source such as an LED or an LD, or an excimer fluorescent lamp.

As illustrated in FIGS. 1A and 1B, in a case where one of the first light source 1 and the second light source 8 is disposed in the inside of the chamber 2, the first light source 1 may be disposed in the inside of the chamber 2. This is because the first light L1 of the first light source 1 has a shorter wavelength than the second light L2 of the second light source 8, and thus, the first light L1 is not easily transmitted through the housing of the chamber 2 as compared to the second light L2. In order to increase the transmittance of the first light L1 through the housing of the chamber 2, a material of the housing of the chamber 2 needs to be selected to have high transmittance even with light having a short wavelength, such as quartz glass. However, by disposing the first light source 1 in the inside of the chamber 2, the first light L1 having a short wavelength does not need to be transmitted through the housing of the chamber 2, and thus, it is possible to widen the choices of materials that can be used for the housing of the chamber 2.

### [Gas to be Treated]

The gas to be treated will be described. The gas G1 which is gas to be treated contains O₂ and N₂O.

O₂ contained in the gas G1 may be O₂ contained in the air. That is, the gas G1 may contain air. In a case where the gas G1 contains air, the gas G1 inevitably contains nitrogen (N₂) and a trace amount of carbon dioxide (CO₂). In addition, the gas G1 may contain water (water vapor that is gas, or atomized water that is liquid).

### [Gas Decomposition of N₂O by First Light]

The N₂O decomposition mechanism by the first light L1 will be described. The decomposition method of N₂O includes direct decomposition by ultraviolet light and indirect decomposition by O(¹D) generated by ultraviolet light.

The direct decomposition of N₂O will be described. When N₂O is irradiated with ultraviolet light hv (≤340 nm) having a wavelength of 340 nm or less, N₂O is decomposed to generate N₂ and O(¹D). This is shown in Formula (1).

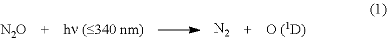

The decomposition reaction of Formula (1) is theoretically caused by ultraviolet light having a wavelength of 340 nm or less. However, because the absorption cross section of light having a wavelength of 200 nm or more with respect to N₂O is small, it is more efficient to use light having a wavelength of less than 200 nm having a relatively large absorption cross section for the decomposition reaction of Formula (1).

Next, indirect decomposition of N₂O will be described. O(¹D) is a highly reactive, highly active substance. When O(¹D) generated by the ultraviolet light comes into contact with N₂O, O₂ and N₂ are generated by Formula (2), or nitrogen monoxide (hereinafter, sometimes referred to as “NO”) is generated by Formula (3).

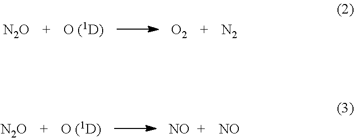

O(¹D) required for the reactions of Formulas (2) and (3) is generated not only by Formula (1) but also by the following Formulas (4) and (5). Note that “hv (≤175 nm)” represents ultraviolet light of 175 nm or less, and “hv (≤ 411 nm)” represents ultraviolet light of 411 nm or less. In the present description, O(³P) represents a ground state oxygen atom (triplet oxygen).

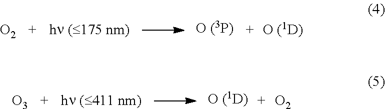

O₃ required for the reaction of Formula (5) is produced through the following reactions of Formulas (1), (4), (6), (7), and (8) (Formulas (1) and (4) are listed again). Formula (6) represents that, as long as the ultraviolet light hv is 242 nm or less, the reaction represented by the Formula (6) occurs. “M” included in Formulas (7) and (8) represents the third body.

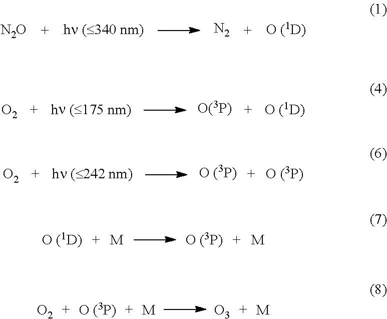

The direct decomposition of N₂O by the ultraviolet light hv and the indirect decomposition of N₂O by O(¹D) generated by the ultraviolet light have been described above. Usually, both of the direct decomposition and the indirect decomposition are performed. The ratio at which the direct decomposition and the indirect decomposition occur varies depending on the gas composition of the gas G1.

### [NOx Cycle Reaction]

It has been described above that NO is generated by Formula (3). NO generated by the reaction of Formula (3) is subjected to the reaction of the following Formula (9) or (10) in the chamber 2. According to Formulas (9) and (10), NO is converted into nitrogen dioxide (hereinafter, sometimes referred to as “NO₂”). On the other hand, NO₂ reacts with the oxygen atom O to generate NO according to the following Formula (11). The oxygen atom O included in Formula (11) includes both O(¹D) and O(³P).

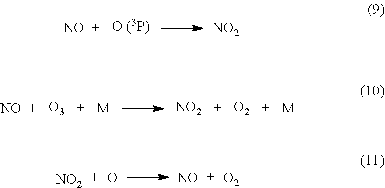

The reaction of producing NO₂ from NO, particularly the reaction of Formula (10), and the reaction of Formula (11) for producing NO from NO₂ are repeated in some cases. This is referred to as the NOx cycle reaction. In the present description, NOx is a concept including NO and NO₂. In the course of the NOx cycle reaction, oxygen atoms O necessary for decomposition of N₂O (see Formula (2)) and O₃ necessary for generation of O(¹D) (see Formula (5)) are continuously consumed. Therefore, when the NOx cycle reaction occurs, the oxygen atoms O and O₃ disappear, and the decomposition of N₂O is prevented.

### [Ozone Decomposition by Second Light]

The present inventors have found that the reaction of Formula (5) is increased by the irradiation with the second light L2 of 411 nm or less. As a result, O(¹D) required for the decomposition of N₂O increases. Furthermore, as O(¹D) increases, O₃ increases through Formulas (7) and (8). This allows the oxygen atoms O and O₃ that disappear in the NOx cycle reaction to be supplemented. Hereinafter, Formulas (5), (7), and (8) are listed again.

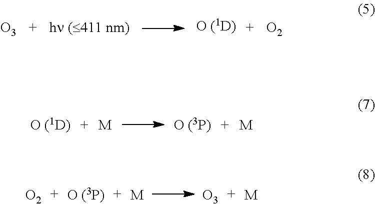

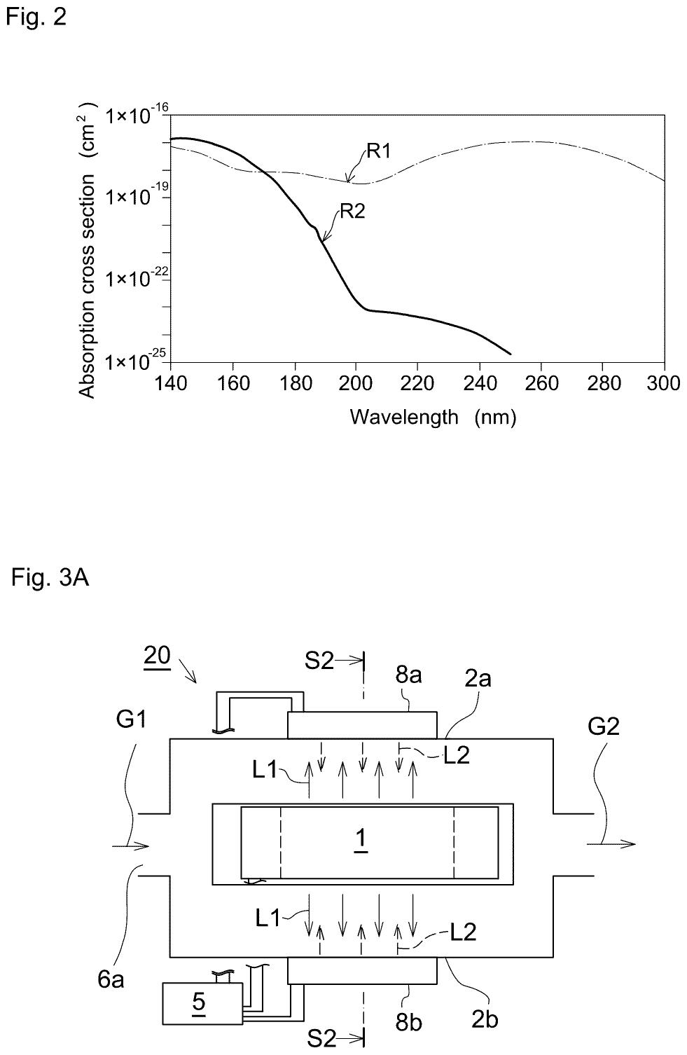

FIG. 2 illustrates an absorption cross section of a molecule with respect to an ultraviolet light irradiation wavelength. An R1 curve (one-dot chain line in FIG. 2) in FIG. 2 represents the absorption cross section of O₃. An R2 curve (solid line in FIG. 2) in FIG. 2 represents the absorption cross section of O₂. From FIG. 2, the absorption cross section of O₃ for ultraviolet light having a wavelength of 200 nm or more is relatively larger than the absorption cross section of ultraviolet light having a wavelength of less than 200 nm. In particular, the absorption cross section of ultraviolet light having a wavelength of 220 nm or more and 280 nm or less is larger than the absorption cross section of ultraviolet light having a wavelength of 160 nm or more and less than 200 nm. As the absorption cross section of O₃ becomes larger, the reaction of Formula (5) proceeds more easily. On the other hand, as seen in the R2 curve, ultraviolet light having a wavelength of 200 nm or more has a small absorption cross section of oxygen, and is hardly attenuated even in the gas to be treated containing relatively high concentration oxygen such as oxygen in air.

That is, the present inventors have found that the second light L2 having a main emission wavelength in a range of 200 nm or more and less than 411 nm from the second light source 8 into the chamber 2 is more suitable for the decomposition of O₃ (reaction of Formula (5)) than the first light L1.

### [Method of Using Gas Decomposition Device]

A method of using the gas decomposition device 10 will be described. Dinitrogen monoxide is largely discharged from human and animal excreta, agricultural and livestock farms, and biomass or waste exhaust gas. Therefore, as described above, in addition to being discharged through a sewer or a septic tank, dinitrogen monoxide is discharged through a process of fermenting biomass or garbage by microorganisms. As a result, dinitrogen monoxide is present in a drainage pipe, a drainage tank, an exhaust pipe, an exhaust tank, and the like of a biomass plant or a waste treatment plant. Microorganisms also release carbon dioxide. However, in the case of a sewer or a septic tank, oxygen having a concentration close to the concentration in the air (about 21 vol %) and a large amount of water are contained by the treatment of aerating with a large amount of air.

Therefore, the gas supply port 3i of the gas decomposition device 10 is connected to a sewer or a septic tank, or a drainage pipe, a drainage tank, an exhaust pipe, an exhaust tank, or the like of a biomass plant, a waste treatment plant, or a chemical plant. In many cases, a proportion of dinitrogen monoxide in the gas to be treated is 5 vol % or less. However, the decomposition method according to the present invention can decompose even a low-concentration gas to be treated having a concentration of such as 5 vol % or less. The gas to be treated may have a concentration of 1 vol % or less.

### First Modification

A first modification of the above embodiment will be described. Hereinafter, matters different from the above embodiment will be mainly described, and description of matters common to the above embodiment will be omitted. The same applies to a second modification described later.

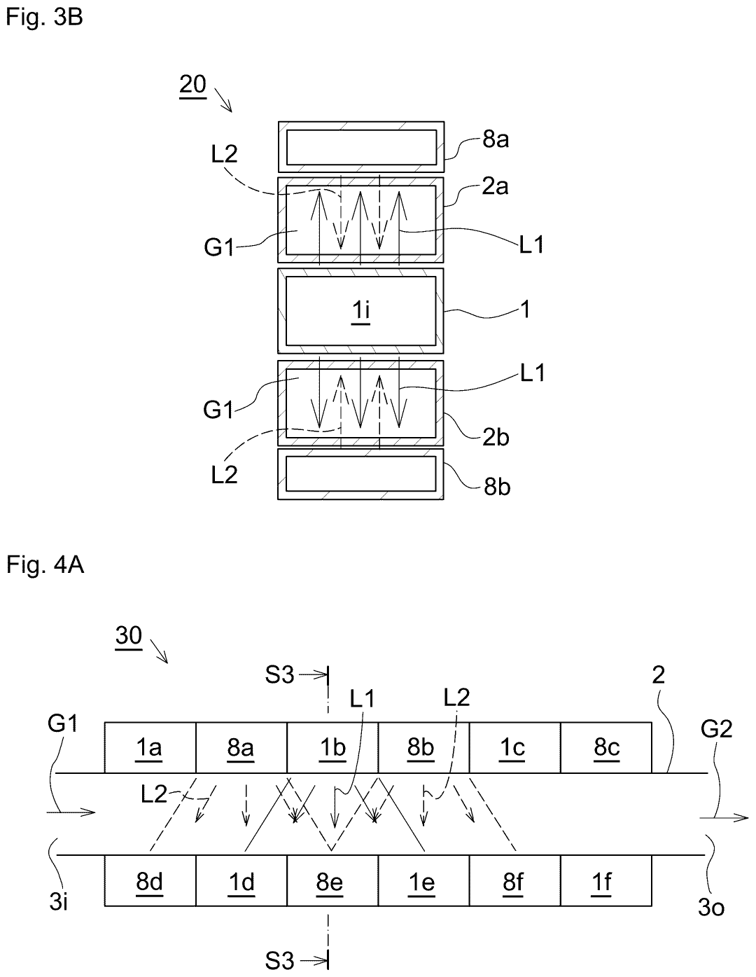

FIG. 3A shows a gas decomposition device 20 of the first modification. FIG. 3B is a cross-sectional view taken along a line S2-S2 in FIG. 3A. As shown in FIGS. 3A and 3B, the gas decomposition device 20 includes a first chamber 2a and a second chamber 2b configured by branching a gas flow path into two. The first light source 1 is disposed outside the first chamber 2a and the second chamber 2b. Because the first light source 1 is outside the chamber (2a, 2b), the first light source 1 can be easily subjected to maintenance, inspection, and replacement.

In the gas decomposition device 20, the first chamber 2a and the second chamber 2b are disposed so as to sandwich the first light source 1. The first light L1 from the first light source 1 can be guided to both the first chamber 2a and the second chamber 2b. Each of the first light source 1, the first chamber 2a, and the second chamber 2b of the present embodiment has a rectangular cross section, and the first light source 1 and the chambers (2a, 2b) are adjacent to each other on the long side. With this configuration, the attenuation amount of the first light L1 reaching the chambers (2a, 2b) can be suppressed.

In the present embodiment, the chambers (2a, 2b) are constituted of a quartz glass tube that transmits the first light L1. However, all the housings constituting the chambers (2a, 2b) do not need to be constituted of the ultraviolet light transmitting material. At least a portion of the chamber required to transmit the first light L1 is preferably constituted of the ultraviolet light transmitting material such as quartz glass. The gas decomposition device 20 may include three or more chambers configured by branching three or more gas flow paths.

A second light source 8a is disposed at a position facing the first light source 1 with the first chamber 2a interposed therebetween. The second light L2 emitted from the second light source 8a overlaps with the first light L1 in the first chamber 2a. Similarly, a second light source 8b is disposed at a position facing the first light source 1 with the second chamber 2b interposed therebetween. The second light L2 emitted from the second light source 8b overlaps with the first light L1 in the second chamber 2b.

### Second Modification

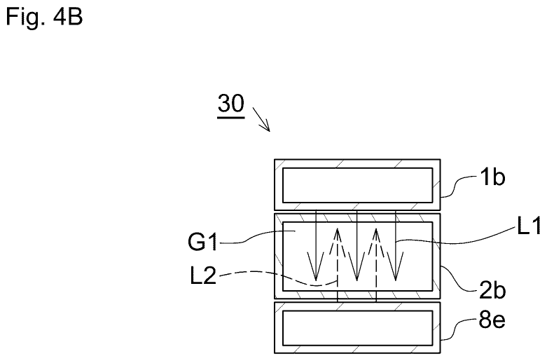

FIG. 4A shows a gas decomposition device 30 of the second modification. FIG. 4B is a cross-sectional view taken along a line S3-S3 in FIG. 4A. As shown in FIG. 4A, in the gas decomposition device 20, first light sources (1a, 1b, 1c) and second light sources (8a, 8b, 8c) are alternately disposed along the flow path direction of the chamber 2. FIG. 4A exemplifies a light beam of the first light L1 and a light beam of the second light L2 only for the first light source 1b and the second light source (8a, 8b). Because each light beam diffuses, the light beam of the first light L1 of the first light source 1b overlaps with the light beams of the second light L2 of the adjacent second light sources (8a, 8b). Although not illustrated, other light sources (1a, 1c, 8c) similarly overlap with the light beams of the adjacent light sources.

In this modification, the first light sources (1d, 1e, 1f) and the second light sources (8d, 8e, 8f) are alternately disposed on the opposite side of the light sources (1a, 1b, 1c, 8a, 8b, 8c) across the chamber 2. The first light L1 and the second light L2 can be emitted from both sides of the chamber 2. In addition, because the first light source 1 (for example, the first light source 1b) and the second light source 8 (for example, the second light source 8e) are disposed to face each other with the chamber 2 interposed therebetween, the first light L1 and the second light L2 emitted from different sides easily overlap with each other.

The embodiment of the gas decomposition method and the gas decomposition device and the modifications thereof have been described above. The above embodiment and the modifications thereof are merely examples of the present invention, and the present invention is not limited to the above embodiment and the modifications thereof at all. Various changes or improvements can be added to the above embodiment and modifications, or the above embodiment or modifications can be combined without departing from the gist of the present invention.

### Example

A gas decomposition simulation was performed under the following conditions.
Gas decomposition device: The gas decomposition device 10 illustrated in FIG. 1A was used.
Composition of gas G1: Air mixed with 100 ppm of N₂O and 100 ppm of H₂O
Flow rate of gas G1: 1 L/min
Chamber 2: A cylindrical pipe having an inner diameter of 38 mm was used.
First light source 1: An excimer lamp (main peak wavelength of 172 nm) having a light emitting tube with an inner diameter of 26 mm and an effective emission length of 800 mm was used.
Illuminance of first light source 1: Set at 72 mW/cm².
Second light source 8: A low-pressure mercury lamp (main peak wavelength of 254 nm) having an effective emission length of 800 mm was used. As illustrated in FIG. 1B, the four second light sources 8 emit light from four directions toward the center of the pipe, and most of the second light L2 overlaps with the first light L1.
Illuminance of second light source 8: Set at 600 mW/cm².

Under a condition S1, only the first light L1 of the first light source 1 was emitted. Under a condition S2, only the second light L2 of the second light source 8 was emitted. Under a condition S3, both the first light L1 of the first light source 1 and the second light L2 of the second light source 8 were emitted. The other conditions of the condition S1, the condition S2, and the condition S3 are common to the above-described conditions.

Table 1 shows simulation results of the N₂O content and the O₃ content of the gas G2 discharged from the chamber 2 and the N₂O decomposition amount in the chamber 2 for each condition (S1 to S3) together with the N₂O content and the O₃ content of the gas G1 supplied to the chamber 2.

TABLE 1

| | GAS G1 | | GAS G2 | | N₂O |
|---|---|---|---|---|---|
| CONDITION | N₂O CONTENT | O₃ CONTENT | N₂O CONTENT | O₃ CONTENT | DECOMPOSITION |
| NUMBER | (ppm) | (%) | (ppm) | (%) | AMOUNT (ppm) |
| S1 | 100 | 0 | 78.3 | 1.654 | 21.7 |
| S2 | 100 | 0 | 100 | 0 | 0 |
| S3 | 100 | 0 | 65.4 | 1.251 | 34.6 |

Table 1 shows the following.

Under the condition S2 (only the second light L2), O₃ is not generated. This is presumed to be because O₃ is not generated due to the absence of the first light L1, and thus, the reaction of Formula (5) does not occur and O(¹D) for decomposing N₂O is not generated. Therefore, N₂O is not decomposed.

In the case of the condition S3 (first light L1+second light L2), the content of O₃ and N₂O is reduced and the N₂O decomposition amount is increased to 1.6 times as compared with the case of the condition S1 (only first light L1). This is presumed to be because O₃ is decomposed to increase O(¹D) for decomposing N₂O, and as a result, more N₂O is decomposed.

### DESCRIPTION OF REFERENCE SIGNS

1, 1a, 1b, 1c, 1d, 1e, 1f First light source
1i Interior (of first light source)
2 Chamber
2a First chamber
2b Second chamber
3i Gas supply port (for supply gas to chamber)
3o Gas discharge port (for gas discharged from chamber)
5 Controller
8, 8a, 8b, 8c, 8d, 8e, 8f Second light source
10, 20, 30 Gas decomposition device
G1 Gas (supplied to chamber)
G2 Gas (exhausted from chamber)
L1 First light
L2 Second light

1. A gas decomposition device comprising:
a pipe through which a gas to be treated containing oxygen and dinitrogen monoxide flows;
a first light source that irradiates an inside of the pipe with first light having a main emission wavelength of 160 nm or more and less than 200 nm; and
a second light source that irradiates the inside of the pipe with second light having a main emission wavelength of 200 nm or more and less than 411 nm, wherein
the first light source and the second light source are disposed such that at least a part of the second light overlaps with at least a part of the first light, and decompose the dinitrogen monoxide.

2. The gas decomposition device according to claim 1, wherein
the first light source is disposed in the inside of the pipe, and the second light source is disposed on an outside of the pipe, and
the pipe includes a transmission region through which the second light passes.

3. The gas decomposition device according to claim 1, wherein the gas to be treated can form a laminar flow in a space to be irradiated with the first light and a space to be irradiated with the second light.

4. The gas decomposition device according to claim 1, wherein the first light source is an excimer lamp.

5. A gas decomposition method comprising:
while a gas to be treated containing oxygen and dinitrogen monoxide is made to flow in to a chamber,
irradiating the chamber with first light having a main emission wavelength of 160 nm or more and less than 200 nm from a first light source; and
irradiating the chamber with second light having a main emission wavelength of 200 nm or more and less than 411 nm from a second light source, the second light being overlapping in at least a part of the second light with at least a part of the first light, and decomposing the dinitrogen monoxide.

6. The gas decomposition device according to claim 2, wherein the first light source is an excimer lamp.

7. The gas decomposition device according to claim 3, wherein the first light source is an excimer lamp.
